(19) United States
(12) Patent Application Publication
(10) Pub. No.: US 2023/0206777 A1
(43) Pub. Date: Jun. 29, 2023

(54) SYSTEM AND METHOD FOR MULTI-PERSON SYNCHRONOUS REMOTE VIRTUAL REALITY TEACHING

(71) Applicant: PAO TE TSAI, Taipei (TW)

(72) Inventor: PAO TE TSAI, Taipei (TW)

(21) Appl. No.: 18/091,042

(22) Filed: Dec. 29, 2022

(30) Foreign Application Priority Data
Dec. 29, 2021 (TW) 110149474

(51) Int. Cl. G09B 7/073

(52) U.S. Cl. CPC G09B 7/073

(57) ABSTRACT

A multi-person synchronous remote virtual reality teaching system and a method thereof, wherein the teacher downloads a virtual reality teaching course files through a teaching information device first, then shares the virtual reality teaching course files with each student to their learning information device. In the way, the student can pre-download the virtual reality teaching course files at the same time. Through the teaching information device, teachers may realize the place where each student's current sight is focused. In addition, the various virtual reality scenes in the above-mentioned devices not only let teachers actively switch or work on for teaching purposes, but also let students browse or study with a certain degree of freedom. Also, multiple hyperlinks are provided in the virtual reality scene for students to click for easy learning.

### BACKGROUND OF INVENTION

### (1) Field of the Present Disclosure

The present disclosure relates to an online teaching system and method, and more particularly to an online teaching system and method that utilizes virtual reality to improve the teaching quality.

### (2) Brief Description of Related Art

Nowadays, online teaching has gradually become a mainstream teaching mode. Teachers can create courses through the Internet and conduct interactive teaching with students.

However, students tend to be less engaged in online teaching for several reasons. For example, the learning content is not rich enough; the curriculum is too standardized; or the teacher cannot always pay attention to the behavior of each student. The learning enthusiasm of students is thus affected because students cannot get the answers to their questions immediately. Therefore, online teaching technology is gradually combined with emerging technologies, such as CN112530219A, which uses AR technology to convert static target teaching information into dynamic three-dimensional virtual images, enhancing the three-dimensional experience when displaying target teaching information.

In addition, when online teaching technology is combined with various modern technology, not only teachers can provide additional information to students online, but students can also browse online information. However, due to the large amount of information or unstable network, long waiting time in the course often reduces the teaching quality and user experience.

### SUMMARY OF INVENTION

It is a primary object of the present disclosure to create a virtual reality classroom and provide one or more virtual reality teaching courses by using a teaching information device on a teaching server. Once the virtual reality teaching course is created, the teaching information device automatically downloads, integrates, and stores information related to the virtual reality teaching course before the start of the course.

Then, the teaching information device converts the created virtual reality teaching course into a link information. When a learning information device is added to the virtual reality teaching course through the link information, it will also automatically download, integrate and store the information related to the virtual reality teaching course in advance.

In addition, the teaching information device and the learning information device can also interact during the virtual reality teaching course. Moreover, the learning information device has a certain degree of freedom to read the information related to the virtual reality teaching course. Students thus can browse or stay at any stage of the virtual reality teaching course at will.

### BRIEF DESCRIPTION OF THE DRAWINGS

FIG. 1 is a framework diagram I of the present disclosure;

FIG. 2 is a block diagram I of the system composition of the present disclosure;

FIG. 3 is a schematic diagram I of the implementation of the present disclosure;

FIG. 4 is a schematic diagram II of the implementation of the present disclosure;

FIG. 5 is a schematic diagram III of the implementation of the present disclosure;

FIG. 6 is a schematic diagram IV of the implementation of the present disclosure;

FIG. 7 is a schematic diagram V of the implementation of the present disclosure;

FIG. 8 is a schematic diagram VI of the implementation of the present disclosure;

FIG. 9 is a framework diagram II of the present disclosure;

FIG. 10 is a block diagram II of the system composition of the present disclosure;

FIG. 11 is a flow chart of the method for implementing the teaching system of the present disclosure;

FIG. 12 is a schematic diagram VII of the implementation of the present disclosure;

FIG. 13 is a schematic diagram VIII of the implementation of the present disclosure;

FIG. 14 is a schematic diagram IX of the implementation of the present disclosure; and

FIG. 15 is a schematic diagram X of the implementation of the present disclosure.

### DETAILED DESCRIPTION OF PREFERRED EMBODIMENTS

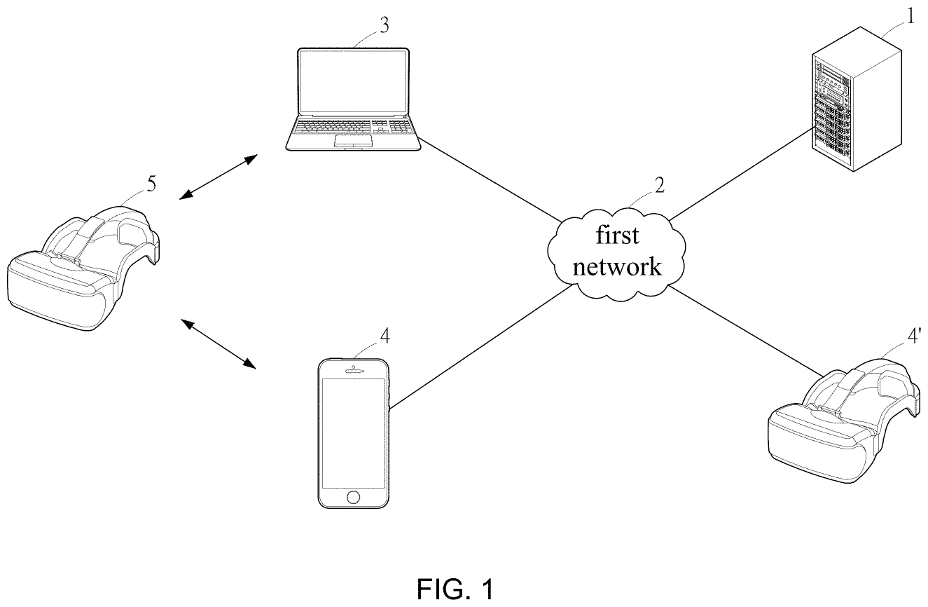

Referring to FIG. 1, the virtual reality multi-person synchronous teaching system of the present invention includes a teaching server 1, which is networked through a first network 2 to a teaching information device 3, and one or more learning information devices 4, 4′ respectively. The users of the teaching information device 3 and the users of the learning information devices 4, 4′ can respectively download the required teaching information from the teaching server 1 through the first network 2. The first network 2 can be one or a combination of a wide area network, a 4G network, a 5G network or a Wi-Fi network. The teaching information device 3 and the learning information device 4 should be any device, such as a mobile phone, a tablet computer, a personal computer, or an all-in-one virtual reality display device that can be connected to the teaching server 1 through the network. In addition, the teaching information device 3 and the learning information device 4 can be used in combination with the virtual reality display device 5, respectively. Thus, the teaching information can be presented in virtual reality through the virtual reality display device 5.

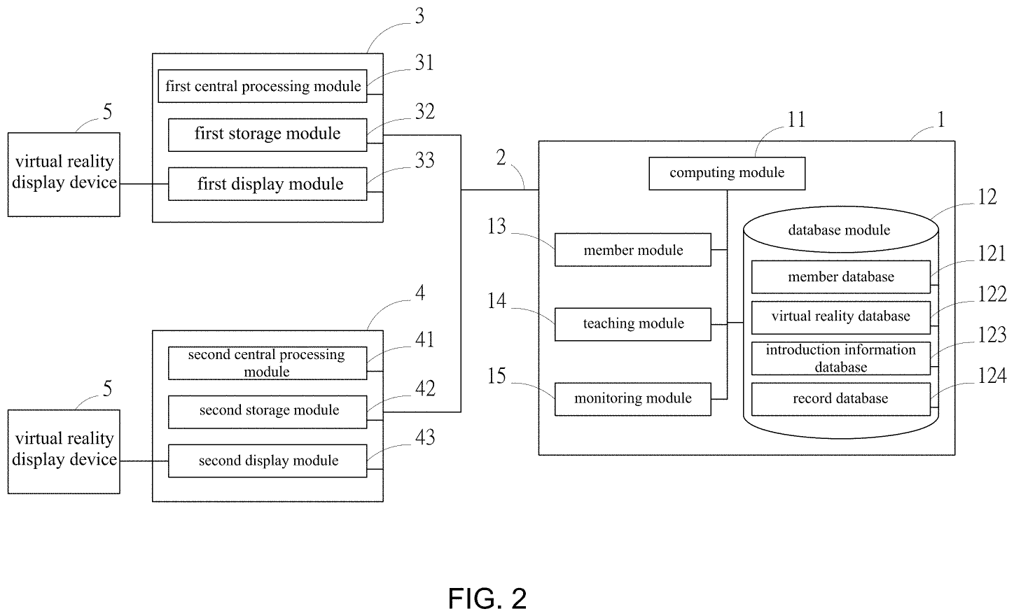

Referring to FIG. 2, the teaching server 1 includes a computing module 11 that is networked with a database module 12, a member module 13, a teaching module 14, and a monitoring module 15 respectively. The teaching information device 3 includes a first central processing module 31, which is networked with a first storage module 32 and a first display module 33 respectively. The learning information device 4 includes a second central processing module 41, which is networked with a second storage module 42 and a second display module 43 respectively.

The computing module 11 can be used to drive all the modules of the teaching server 1, receive and send information signals from the teaching information device 3 or the learning information device 4. It can also be a central processing unit, which has the following functions: logical calculation, temporarily storing calculation results, and saving the location of executing instructions.

The database module 12 includes a member database 121, a virtual reality database 122, an introduction information database 123 and a record database 124. The database module 12 may be a solid state disk or one or a combination of solid state disk, hard disk. drive, static random access memory or random access memory. In any embodiment, the database module 12 is not limited to a single server, but can be several distributed databases which are managed by Byzantine Fault Tolerant on the blockchain network.

The member database 121 can be used to store a member information and a visitor information. The member information can be one or a combination of account number, password, name, picture, phone number, address or biometric information. The visitor information can be a time stamp or a temporary account left by the user using the above non-member information to connect to the teaching server 1. The virtual reality database 122 can be used to store an information related to the virtual reality teaching course, including but is not limited to an ecological guiding course, an educational demonstration course, a technical practice course, or an art exhibition course, etc. The introduction information database 123 can be used to store an introduction information related to virtual reality teaching course. The introduction information can be one or a combination of a text information, a picture information, an audio-visual information or a 3D model, including but is not limited to brief introduction texts of animals and plants, audio guidance of historical stories, technical teaching videos, etc. The record database 124 can be used to store at least one course history record of the learned lesson. The course history record can be any records of the user's operation in the system of the present disclosure, including the creation records of the classrooms and courses in the server, or the interactive records between users of the teaching information device 3 and users of the learning information device 4 in the process of virtual reality teaching. The interactive records include the questions raised by teachers, the supplementary notes, or the feedbacks from the students, etc.

The member module 13 can be used to connect to the teaching server 1 through an application by the user of the teaching information device 3 or the learning information device 4. When the user thereof connects to the teaching server 1, the member module 13 can distinguish whether the user is a registered member or a visitor according to the member information in the member database 121. Thus, the member module 13 can give different users different level of permission. The permission level can be divided into a first-level permission, a second-level permission, and a general permission. The user can perform different functions according to the permission level.

According to another embodiment, the member module 13 can also provide the user of the teaching information device 3 with the main permission to change the permission level of permitted objects in another embodiment. The permitted objects can be the user of the teaching information device 3 or the user of the learning information device 4. For example, if a teacher, the user of the teaching information device 3, wants to assign an user of the learning information device 4 to a teaching assistant, the teacher can change the permission level of the user of the designated learning information device 4 to the second-level permission. At the same time, a record of the changed permission level is updated and stored in the member's or visitor's information in the member database 121. In this way, the teacher or the user of the teaching information device 3 does not need to re-assign teaching assistants in every course.

The teaching module 14 allows the user of the teaching information device 3 to create one or more virtual reality classrooms or courses on the teaching server 1. In one embodiment, the user can create a virtual reality teaching course of his choice, and at the same time create a corresponding virtual reality classroom. In another embodiment, the user can create a virtual reality classroom in advance, and then choose and create a virtual reality teaching course in the virtual reality classroom. In a further embodiment, the user can use the previous virtual reality classroom or virtual reality teaching course according to the history records of the courses in the record database 124, without creating the virtual reality classroom or virtual reality teaching course again. Furthermore, the teaching module 14 allows the user of the teaching information device 3 to switch between multiple virtual reality teaching courses according to the needs of teaching.

The teaching module 14 can also be used by the user of the teaching information device 3 to convert the created virtual reality classroom or virtual reality teaching course into a link information that can be shared to the other users. The link information can be one or a combination of a two-dimensional barcode, uniform resource locators (URLs), an identification code or any other transmittable data packet. To be more specific, the two-dimensional barcode can be one of PDF417, QR, Hanxin, ColorCode, DataMatrix, Aztec and QuickMark. The identification code can be one or a combination of numbers, symbols or English letters.

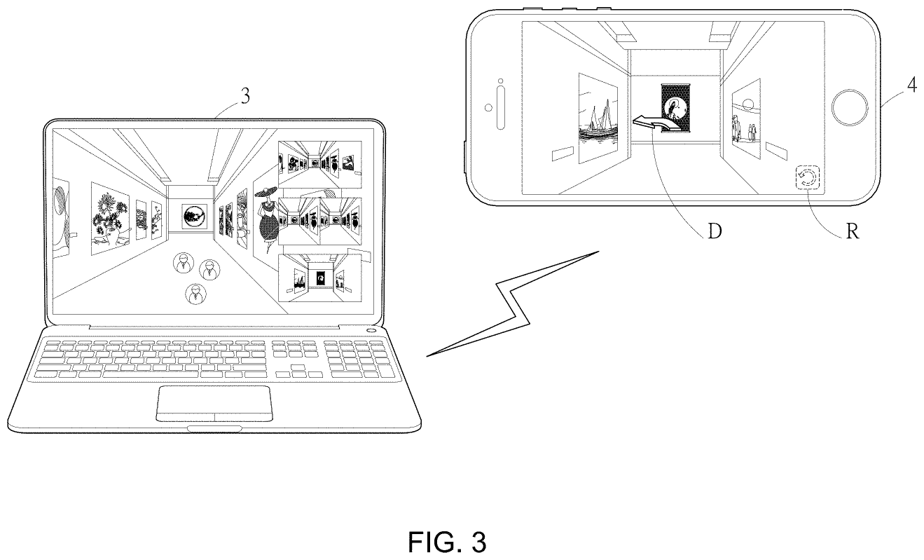

Referring to FIG. 3, the teaching module 14 can allow the user of the learning information device 4 to enter a free exploration mode. In this way, the user can have a certain degree of freedom to browse or stay at any stage of the virtual reality teaching course at will. The teaching module 14 can also allow the user of the teaching information device 3 to enter a guidance mode when the user wants to share important information or help users who use the learning information device 4 and are unable to follow the current teaching step. In other words, the second display module 43 of multiple learning information devices 4, 4′ can be controlled by the user of the teaching information device 3 to simultaneously present the teaching stage displayed by the first display module 33 of the teaching information device 3. For example, when the user of the teaching information device 3 wants to introduce oil paintings in the exhibition hall, the second display module 43 of the learning information devices 4, 4′ can be controlled to display the scene of the exhibition hall. At the same time, the user of the teaching information device 3 can reduce the degree of freedom of the user of the learning information device 4 by closing the free exploration mode function R. When the second display module 43 of the learning information device 4 is converted into the scene of the exhibition hall and if the user of the learning information device 4 is in a different exhibition area, the second display module 43 will simultaneously display a guidance indicator D such that the user of the learning information device 4 can follow the guidance indicator D to get access to the oil painting that the user of the teaching information device 3 wants to introduce. In this way, the user of the teaching information device 3 can control the teaching progress and ensure that the user of the learning information device 4 can keep up with the progress of the course.

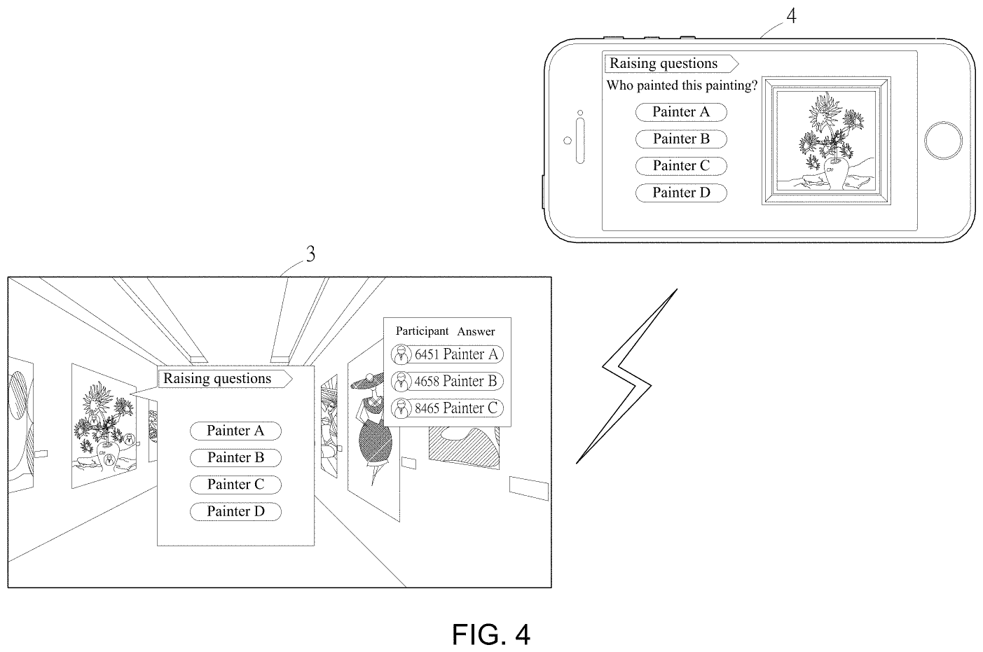

Referring to FIG. 4, the teaching module 14 can allow the user of the teaching information device 3 to operate under the guidance mode. When the virtual reality teaching course is in progress under the guidance mode, the user of the teaching module 14 can ask one or more questions to the user of the learning information device 4 according to the related information of the virtual reality teaching course. The teaching module 14 also synchronously stores the aforementioned questions in the record database 124. After the user of the learning information device 4 answers the question, the answer will be sent back to the teaching information device 3 through the network. Then the answers of different users of the learning information device 4 can be presented through the first display module 33.

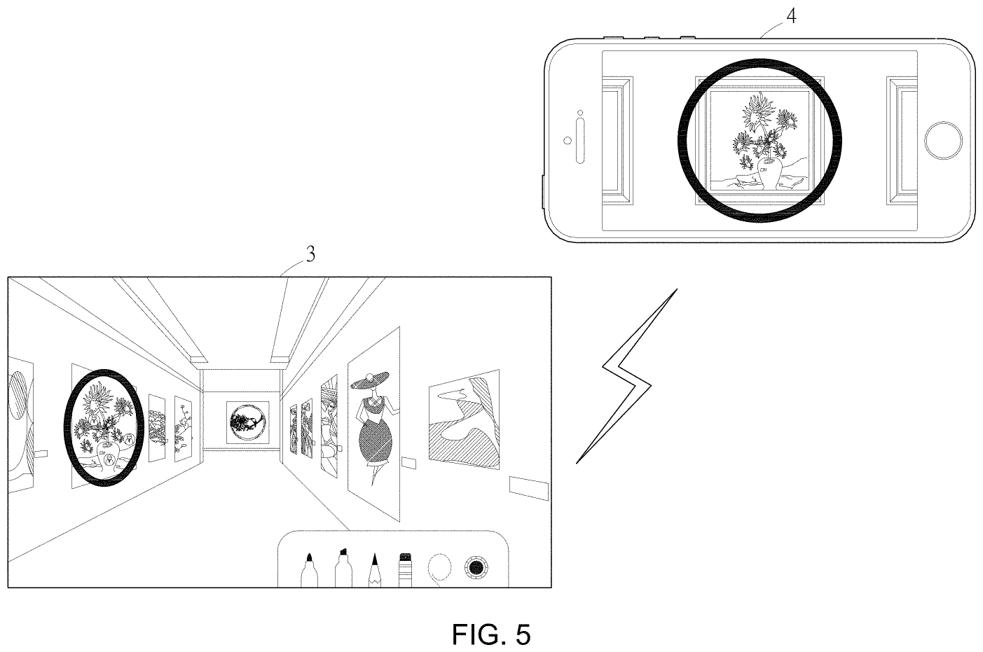

In one embodiment, the teaching module 14 can be used by the user of the teaching information device 3 in a guidance mode to share supplementary information to the user of the learning information device 4 when the virtual reality teaching course is in progress. Moreover, the teaching module 14 also synchronously stores the supplementary information in the record database 124. For example, referring to FIG. 5, when the user of the teaching information device 3 wants to share key points to the user of the learning information device 4, he can directly share the marked content or the inserted video, such as underlined text, sound, video, etc., through the teaching module 14 to the second display module 43.

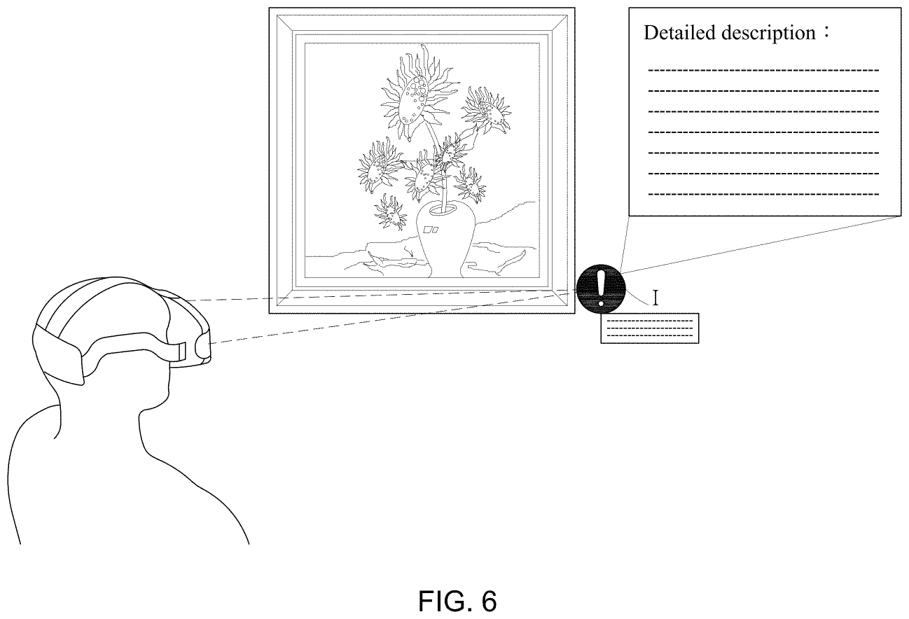

Referring to FIG. 6, the teaching module 14 can allow the user of the learning information device 4 to get access to the free exploration mode. In the progress of the virtual reality teaching course, when the directivity of the learning information device 4 or the virtual reality display device 5 is aligned with an information symbol I in the virtual reality scene within the scope of the viewing angle, the devices thereof can read one or a combination of text, pictures, videos, or 3D models of the introduction information. For example, a plurality of hyperlinked information symbols I have been set in the scene of the virtual reality teaching course. Even if the user of the teaching information device 3 cannot respond to the question, the user of the learning information device 4 can also align the learning information device 4 or the virtual reality display device 5 to the information symbol I within the scope of the viewing angle. In this way, the user may obtain the answers to the questions or more information related to the learning in time.

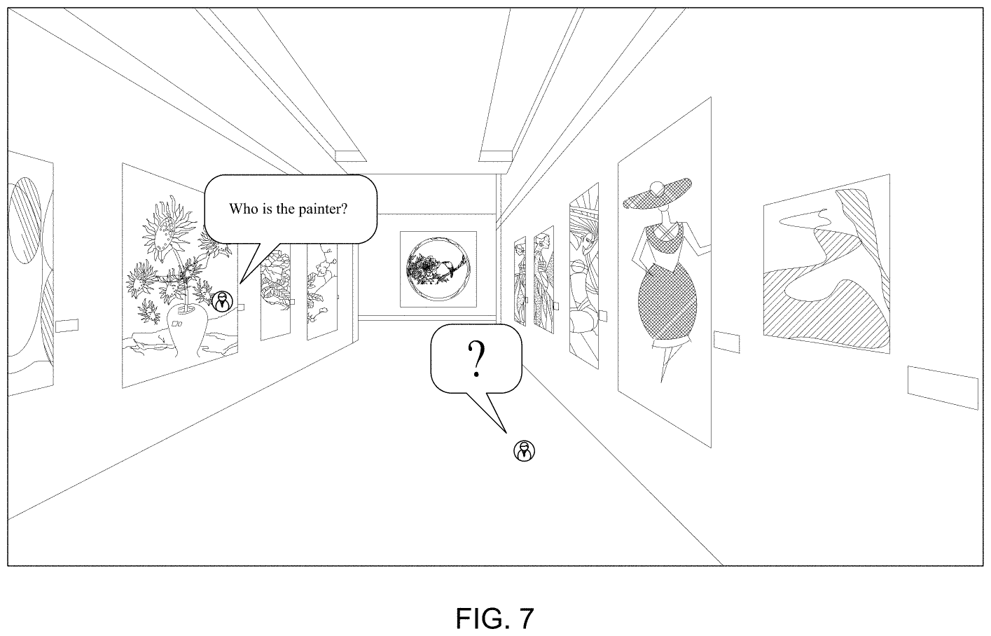

In one embodiment, the teaching module 14 can allow the user of the learning information device 4 in the guidance mode to ask one or more questions to the user of the teaching information device 3 in the progress of the virtual reality teaching course. For example, referring to FIG. 7, when the user of the learning information device 4 has the question about the author of the painting, or has doubts about the content explained by the user of the teaching information device 3, the user of the learning information device 4 can ask the question through the teaching module 14, then the first display module 33 of the teaching information device 3 can present the text or emoticons about the question.

The monitoring module 15 can be used by the user of the teaching information device 3 to monitor the progress on downloading or integrating the virtual reality teaching and introduction information of the learning information device 4. In addition, the monitoring module 15 can present one or more pieces of information of the progress thereof through the first display module 33. In this way, the user of the teaching information device 3 may understand the status of the data downloaded by the user of the learning information device 4. In addition, it can be decided whether to start the virtual reality teaching course or not.

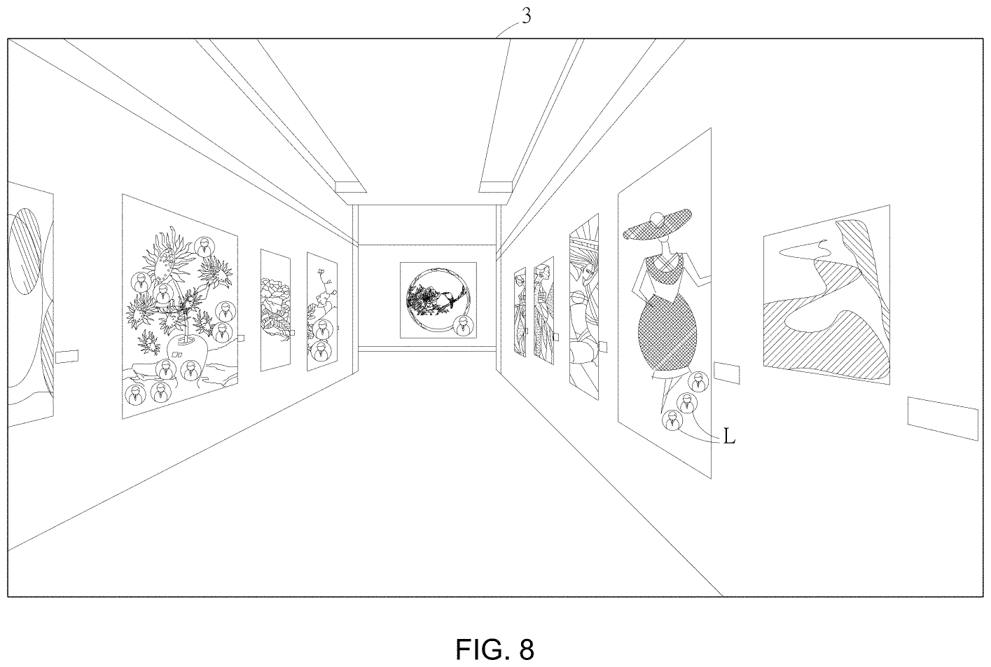

Referring to FIG. 8, by means of a browsing sign L offered by the monitoring module 15 in the virtual reality teaching course scene, the user of the teaching information device 3 can monitor the learning progress of the user of the learning information device 4. The browsing sign L presented on the first display module 33 includes, but is not limited to, logos, pictures, virtual characters, etc. For example, the user of the learning information device 4 can freely browse or stay in any stage of the virtual reality teaching course. A browsing sign L will be formed within the range of the viewing angle of the user of the learning information device 4. The user of the teaching information device 3 then can monitor the browsing position of the user of the learning information device 4 in the visual reality course scene through the monitoring module 15. In this way, the user of the teaching information device 3 can control the learning progress of the user of the learning information device 4.

The first central processing module 31 can be used to drive every module of the teaching information device 3. It can also be a central processing unit that has the functions of logical computing, temporarily storing computing results, and saving the position of executing instructions. After the user selects the course to be created, the first central processing module 31 downloads the information related to the virtual reality teaching course from the virtual reality database 122 and the introduction information from the introduction information database 123. The download may be performed according to the user's choice or an automatic schedule preset by the user. Simultaneously, the first central processing module 31 can perform an edge computing process to integrate the aforementioned information into an integrated information and store each information to the first storage module 32. In this way, the user of the teaching information device 3 can download the relevant information of the virtual reality teaching course before the start of the course. The user of the teaching information device 3 thus does not need to spend additional time downloading information when the course is in progress, thereby improving the teaching quality and the user's experience.

The second central processing module 41 can be used to drive every module of the learning information device 4. It can also be a central processing unit that has the functions of logical computing, temporarily storing computing results, and saving the position of executing instructions. After the user of the teaching information device 3 shares the link information, the second central processing module 41 can join the virtual reality classroom or course created by the user of the teaching information device 3. Then the second central processing module 41 will automatically start to download the information related to the virtual reality teaching course from the virtual reality database 122 and the introduction information from the introduction information database 123. Simultaneously, the second central processing module 41 can perform an edge computing process to integrate the aforementioned information into an integrated information and store each information to the second storage module 42. In this way, the user of the learning information device 4 can download the relevant information of the virtual reality teaching course before the start of the course. The user of the learning information device 4 thus does not need to spend additional time downloading information when the course is in progress, thereby improving the learning quality and the user's experience.

In another embodiment, the user of the teaching information device 3 can download the information related to the virtual reality teaching course from the virtual reality database 122 and the introduction information from the introduction information database 123 in advance. After the information edited and integrated by the first central processing module 31, the integrated information can be uploaded to the teaching server 1. In this way, the user of the learning information device 4 can directly download the integrated information, while the learning information device 4 does not need to perform the edge computing process again.

According to an embodiment, the virtual reality classroom created by the user of the teaching information device 3 may include more than one virtual reality teaching courses. The second central processing module 41 will automatically download the part of the information related to the virtual reality teaching courses and the introduction information which is specified by the user of the teaching information device 3 when the user of the learning information device 4 joins the virtual reality classroom. When the user of the teaching information device 3 needs the rest part of the information for teaching, the user can switch between multiple virtual reality teaching courses. Meanwhile, the second central processing module 41 will download them synchronously through the streaming media. In this way, it is not necessary to wait for a long time downloading all the information before entering the virtual reality teaching course especially for the user of the learning information device 4 who cannot enter the virtual reality classroom on time. In addition, it also avoids wasting the storage space of the second storage module 42, thereby improving the teaching quality and the user's experience.

The first storage module 32 and the second storage module 42 can be used to store electronic data downloaded by the database module 12 of the teaching server 1 respectively. The electronic data includes the information related to the virtual reality teaching course of the virtual reality database 122 and the introduction information related to the virtual reality teaching course of the introduction information database 123. The electronic data may be one or a combination of text information, picture information, video information, or 3D models. In addition, the first storage module 32 and the second storage module 42 can be respectively one or a combination of solid state disk or solid state drive, hard disk drive, static random access memory, or random access memory.

After the end of the virtual reality teaching course, the first storage module 32 and the second storage module 42 may download the user's history record in the database 124 respectively. The download may be performed according to the user's choice or an automatic schedule preset by the user. In this way, the users of the information devices can not only review the completed virtual reality teaching courses, but also obtain additional supplementary information, such as questions raised by the teacher, supplementary annotations, or the feedbacks given by students.

The first display module 33 can display the information of the virtual reality teaching course, introduction information, and user's history in the first storage module 32. The second display module 43 can display the information of the virtual reality teaching course, introduction information, and user's history in the second storage module 42. The teaching information device 3 and the learning information device 4 can be used in combination with the virtual reality display device 5 respectively. In this way, the information displayed by the first display module 33 or the second display module 43 can be presented in virtual reality through the virtual reality display device 5.

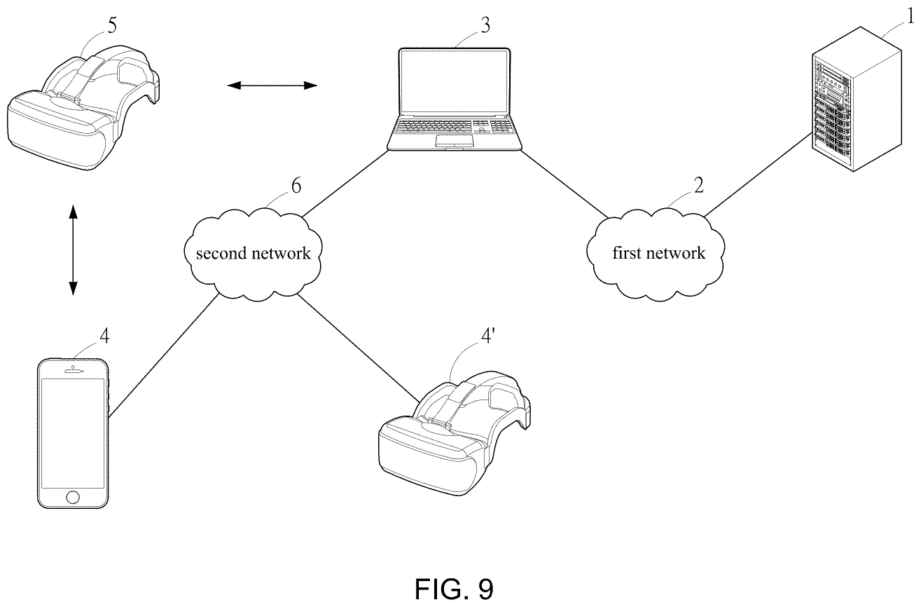

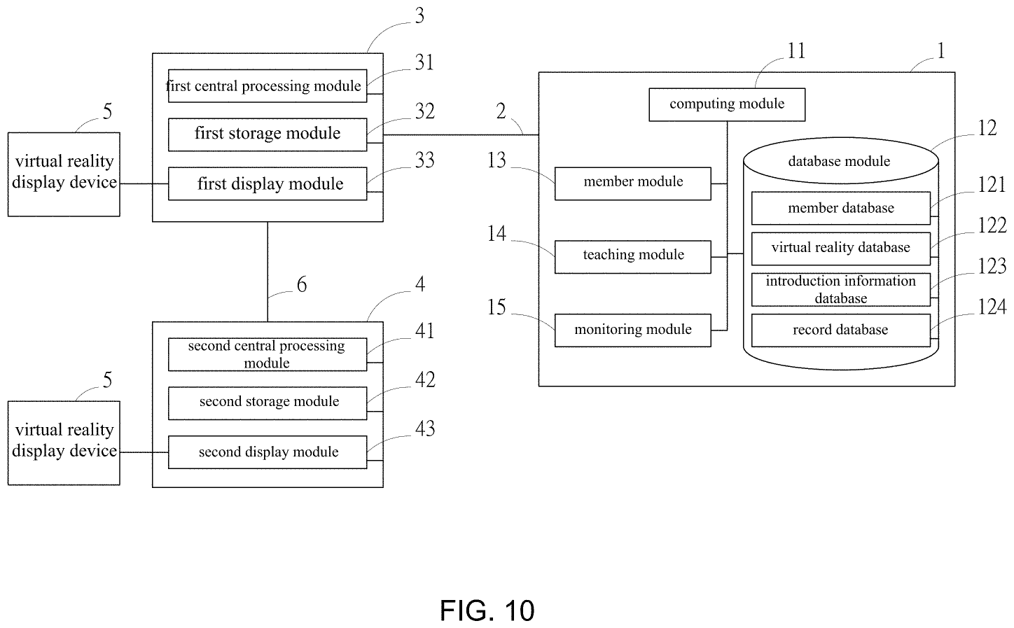

Referring to FIG. 9 and FIG. 10, the teaching server 1 of the present disclosure relates to a multi-person synchronous teaching system with virtual reality in connection with the teaching information device 3 through the first network 2. Being different from the above-mentioned embodiment, the teaching information device 3 of this embodiment is then connected to one or more learning information devices 4 and 4′ through a second network 6. In this way, the learning information devices 4 and 4′ do not need to be connected to the teaching server 1 through the first network 2. The second network 6 can be one or a combination of a local area network, a wide area network, a 4G network, a 5G network, a Wi-Fi network, or a Bluetooth network. Preferably, the second network 6 is a local area network. Through the local area network, the second central processing module 41 of the learning information device 4 can automatically download the information related to the virtual reality teaching course or the integrated information from the first storage module 32 of the teaching information device 3. At the same time, the second central processing module 41 of the learning information device 4 can store the aforementioned information in the second storage module 42. As a result, the learning information device 4 will not spend a lot of time waiting on data processing due to the unstable network status, thereby improving the teaching quality and the user's experience.

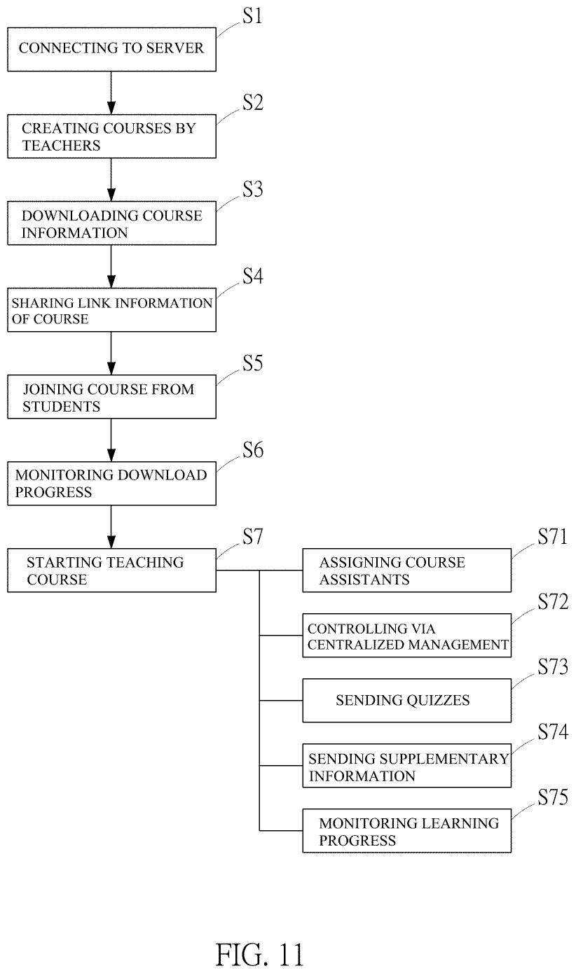

FIG. 11 is a flow chart of the implementation of the teaching system of the present disclosure. Every step will be detailed as follows:

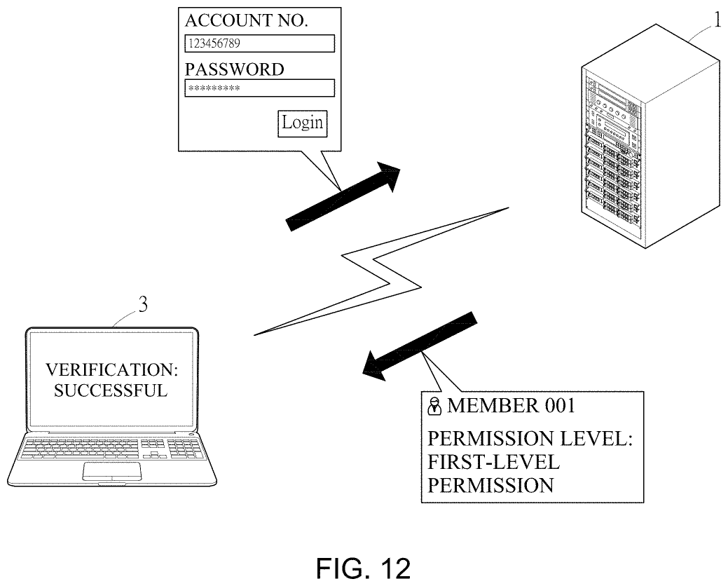

Step S1: Connecting to server. Referring to FIG. 12, the user of the teaching information device 3 can send the login information to the teaching server 1 through an App. The login information can be one or a combination of account number, password, name, picture, phone number, address, or biometric information, etc. Meanwhile, the member module 13 compares the login information with the member information in a member database 121. The member information can be one or a combination of information such as account number, password, name, picture, phone number, or address. If the login information is matched with the member information, the user is identified as a registered member. Then, the permission level of the user will be set as the first-level permission. The permission levels can be divided into the first-level permission, the second-level permission, and the general permission.

Step S2: Creating courses by teachers. The user of the teaching information device 3 sends a creation information to the teaching server 1. Meanwhile, the teaching module 14 creates one or more virtual reality classrooms or virtual reality teaching courses according to the creation information. In one embodiment, the virtual reality teaching course and the corresponding virtual reality classrooms may be created with different creation information at the same time. In another embodiment, the virtual reality classroom may be created first, and then the corresponding virtual reality teaching course is created. In a further embodiment, the virtual reality classroom or the corresponding virtual reality teaching course may be created for teaching according to the virtual reality classroom or the virtual reality teaching course created in the previous embodiments.

Step S3: Downloading course information. After the virtual reality teaching course is created, the first central processing module 31 downloads the information related to the virtual reality teaching course from the virtual reality database 122 and the introduction information from the introduction information database 123. The information may be one or a combination of a text information, a picture information, a video information, or a three-dimensional model. The download may be performed according to the user's choice or an automatic schedule preset by the user. The first central processing module 31 can also perform the edge operation to integrate the aforementioned information into an integrated information and store each information to the first storage module 32.

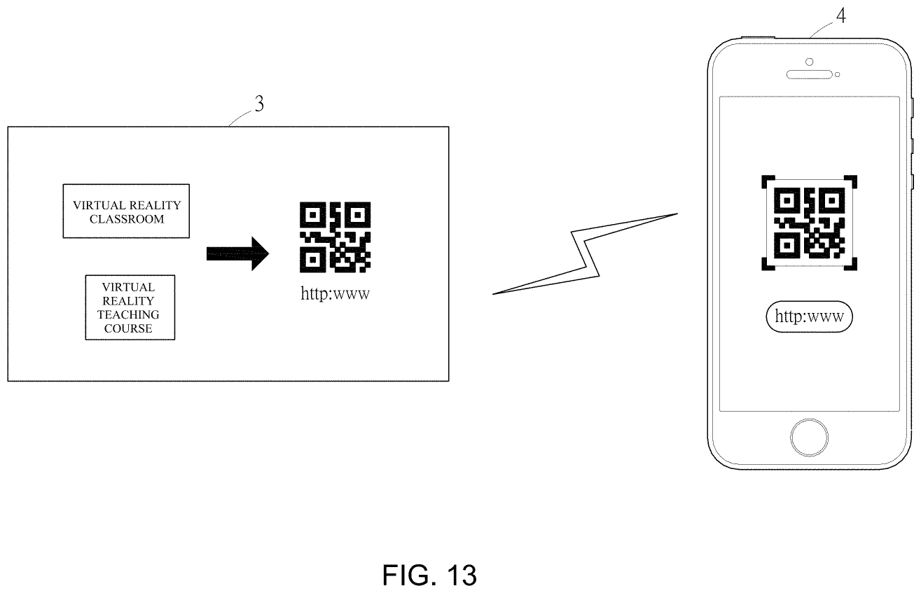

Step S4: Sharing the link information of the course. Referring to FIG. 13, the teaching module 14 can convert the created virtual reality classroom or the virtual reality teaching course into a link information when the user of the teaching information device 3 sends a sharing signal to the teaching server 1. Then, the user of the teaching information device 3 can share the virtual reality classroom or the virtual reality teaching course with the user of the learning information device 4 through the link information. The link information can be one or a combination of a two-dimensional barcode, uniform resource locator, or an identification code. To be more specific, the two-dimensional barcode can be one of PDF417, QR, Hanxin, ColorCode, DataMatrix, Aztec, or QuickMark. The identification code can be one or a combination of numbers, symbols or English letters.

Step S5: Joining the course from students: The user of the learning information device 4 can join the virtual reality classrooms or the virtual reality teaching courses through the link information. At the same time, the member module 13 determines that the user enters the virtual reality classroom or the virtual reality teaching course in a visitor mode (that is, a non-registered member) according to the link information. The member module 13 then sets the permission level of the user as the general permission, and store the information in the member database 121 as a visitor information. In addition, the second central processing module 41 will automatically start to download the information related to the virtual reality teaching course from the virtual reality database 122 and the introduction information from the introduction information database 123 after the user of the teaching information device 3 shares the link information. At the same time, the second central processing module 41 can perform an edge operation to integrate the aforementioned information into an integrated information and store each information to the second storage module 42.

According to an embodiment, the virtual reality classroom created by the user of the teaching information device 3 may include more than one virtual reality teaching courses. The second central processing module 41 will automatically download the part of the information related to the virtual reality teaching courses and the introduction information which is specified by the user of the teaching information device 3 when the user of the learning information device 4 enters the virtual reality classroom. When the user of the teaching information device 3 needs the rest part of the information for teaching, the user can switch between multiple virtual reality teaching courses. Meanwhile, the second central processing module 41 will download them synchronously through a streaming media.

In one embodiment, the user of the learning information device 4 may send the login information to the teaching server 1 in a membership mode (that is, a registered member). That is, no matter the user of the teaching information device 3 or the user of the learning information device 4, the member module 13 will compare the login information sent to the teaching server 1 with the member information in the member database 121. For the user of the teaching information device 3, the member module 13 then only sets the permission level of the user as the general permission, while the user should own the first-level permission. In this case, the login information and the member information of the user of the teaching information device 3 further include an identification code. In the way, the member module 13 only needs to determine the user's identity as the user of the teaching information device 3 based on the identification code and then grants the user the first-level permission if the identification code is valid. The member module 13 thus does not need to determine if the login information matches to the member information.

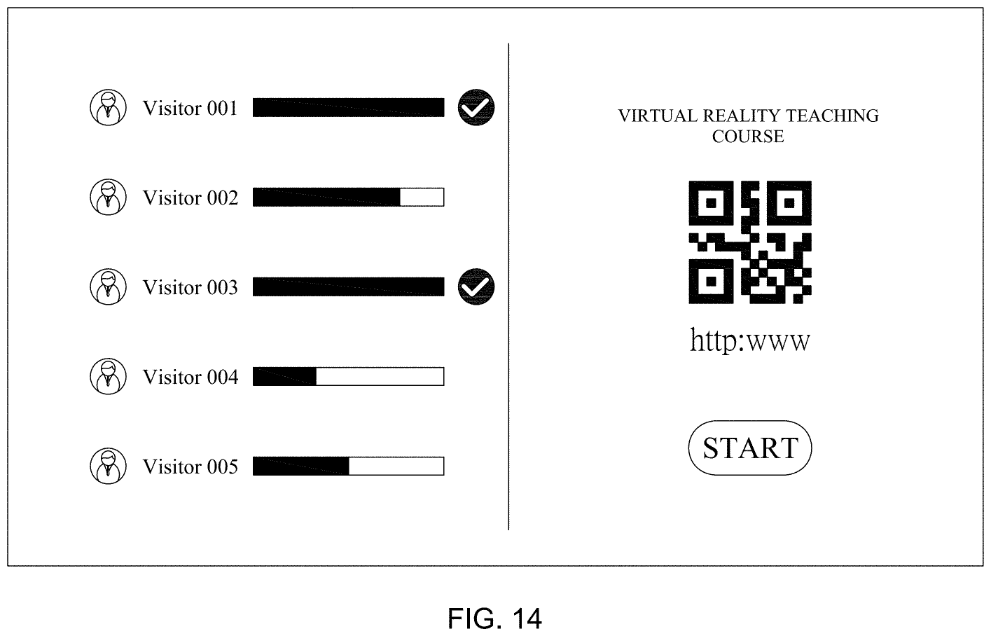

Step S6: Monitoring download progress. Referring to FIG. 14, when the second central processing module 41 is downloading or integrating the information related to the virtual reality teaching course, the monitoring module 15 sends one or more pieces of progress information to the teaching information device 3. The progress then can be presented through the first display module 33.

Step S7: Starting teaching course. After the user of the learning information device 4 joins the virtual reality teaching course, the user of the teaching information device 3 then can send a start signal to the teaching server 1 to start the virtual reality teaching course. The progress of a virtual reality teaching course may include the assignment of course assistants, central control management, quizzes, supplementary information or the monitoring of the learning progress. The further details of the above-mentioned progress of the start of the course will be given below. The step of S7 (Starting teaching course) includes the following steps:

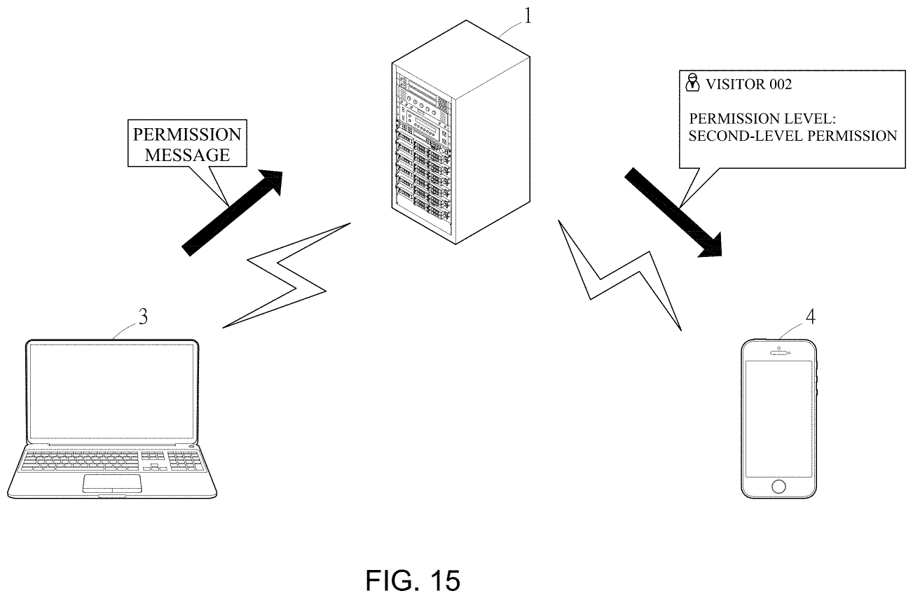

Step S71: Assigning course assistants. Referring to FIG. 15, the user of the teaching information device 3 can send a permission message for changing the permission level of an authorized person to the teaching server 1. According to the permission message, the member module 13 changes the permission level of the authorized person and stores the record of changing the permission level to the member information or the visitor information in the member database 121. The authorized person can be the user of the teaching information device 3 or the user of the learning information device 4. For example, the user of the teaching information device 3 wants to assign the user of the learning information device 4 to the course assistant. Thus, the user of the teaching information device 3 sends a permission message to the teaching server 1 such that the permission level of the user of the learning information device 4 is changed from the general permission to the second-level permission.

Step S72: Controlling via centralized management. The user of the teaching information device 3 can send a control signal to the teaching server 1. According to the control signal, the teaching module 14 simultaneously controls the second display module 43 of the learning information devices 4 and 4′ to synchronize the learning information devices with the first display module 33 of the teaching information device 3. For example, since the user of the learning information device 4 has a certain degree of freedom, the user can freely browse or stay in any stage of the virtual teaching course. When there is a need of the user of the teaching information device 3 to share important information or to help the user who cannot follow the current step of the course on the learning information device 4, the second display module 43 of the learning information devices 4 and 4′ can be switched to synchronize with the first display module 33 of the teaching information device 3.

Step S73: Sending quizzes. The user of the teaching information device 3 can send one or more questions related to the virtual reality teaching course to the user of the learning information device 4 through the network. The questions are presented through the second display module 43 and are stored as test information in the record database 124 synchronously. After the user of the learning information device 4 answers the question, the answer can be sent back and presented through the first display module 33 of the teaching information device 3 through the network.

Step S74: Sending supplementary information: During the virtual reality teaching course, the user of the teaching information device 3 can send supplementary information to the learning information device 4 through the network for supplementing additional learning information to the user of the learning information device 4. The supplementary information is presented through the second display module 43 and stored as the supplementary information in the record database 124 synchronously. The supplementary information may be the notes that the user of the teaching information device 3 wants to share to the user of the learning information device 4, such as underlined text, sound, or video, etc.

Step S75: Monitoring the learning progress, no matter where the user of the learning information device 4 is browsing or staying at any stage of the virtual reality teaching course, the learning information device 4 will send the location information of the user of the learning information device 4 to the teaching server 1. The monitoring module 15 then transmits the location information to the teaching information device 3 and presents it through the first display module 33. The user of the teaching information device 3 thus can realize the learning status of the user of the learning information device 4.

According to the present disclosure, the teaching information device can download the information related to the virtual reality teaching course according and perform the edge computing process for integrating the downloaded information. The download can be performed according to the user's choice or an automatic schedule preset by the user. In addition, when the learning information device joins the virtual reality teaching course through the link information, the learning information device can also automatically download the information related to the virtual reality teaching course and perform the edge computing process for integrating the download information.

Furthermore, the teaching information device and the learning information device can interact in the virtual reality teaching course, while the learning information device still has a certain degree of freedom that the user of the learning information can browse or stay at any stage of the virtual reality teaching course at will such that the user of the learning information can obtain the information or answers to the questions related to the course from the virtual reality scene. According to the details above, the present disclosure relates to a multi-person synchronous teaching system with virtual reality and a method thereof can indeed achieve the purpose of increasing the richness of course content, allowing students to get feedback immediately and reducing data transmission time.

### REFERENCE SIGN

1 teaching server
11 computing module
12 database module
121 member database
122 virtual reality database
123 introduction information database
124 record database
13 member module
14 teaching module
15 monitoring module
2 first network
3 teaching information device
31 first central processing module
32 first storage module
33 first display module
4, 4′ learning information device
41 second central processing module
42 second storage module
43 second display module
5 virtual reality display device
6 second network
I information symbol
L browsing sign
D guidance indicator
R free exploration mode function
S1 connecting to server
S2 creating courses by teachers
S3 downloading course information
S4 sharing link information of class
S5 joining courses from students
S6 monitoring download progress
S7 starting teaching course
S71 assigning course assistants
S72 controlling via centralized management
S73 the quizzes
S74 the supplementary information
S75 monitoring learning progress

What is claimed is:

1. A multi-person synchronous remote virtual reality teaching system, comprising:
a teaching server for creating a virtual reality classroom or a virtual reality teaching course and for converting the virtual reality classroom or the virtual reality teaching course into a link information;
a teaching information device being in information connection with the teaching server through a first network and having a first central processing module and a first storage module, wherein the first central processing module is provided for downloading a virtual reality teaching information and an introduction information in the database module after the virtual reality teaching course is created optionally or automatically if the module has been preset, executing an edge operation to integrate the virtual reality teaching information and the introduction information into an integrated information and storing the integrated information in the first storage module; and
a learning information device being in information connection with the teaching server through a second network and having a second central processing module and a second storage module, wherein, when the learning information device joins the virtual reality teaching course through the link information, the second central processing module is provided for automatically downloading the integrated information from the first storage module and storing the integrated information in the second storage module.

2. The multi-person synchronous remote virtual reality teaching system as claimed in claim 1, wherein, when the second central processing module is in information connection with the teaching server through the first network and after the learning information device joins the virtual reality teaching course through the link information, the second central processing module automatically downloads the virtual reality teaching information and the introduction information in the database module, executes the edge operation to integrate the virtual reality teaching information and the introduction information into the integrated information and then stores the integrated information in the second storage module.

3. The multi-person synchronous remote virtual reality teaching system as claimed in claim 1, wherein, in creating the virtual reality classroom or the virtual reality teaching course, the teaching module is used to pre-create the virtual reality teaching course and simultaneously create the virtual reality classroom.

4. The multi-person synchronous remote virtual reality teaching system as claimed in claim 1, wherein, in creating the virtual reality classroom or the virtual reality teaching course, the teaching module is used to pre-create the virtual reality classroom and then create the virtual reality teaching course.

5. The multi-person synchronous remote virtual reality teaching system as claimed in claim 1, wherein, in creating the virtual reality classroom or the virtual reality teaching course, the teaching module is used to create a past virtual reality classroom or a past virtual reality teaching course according to a historical course record of the database module.

6. The multi-person synchronous remote virtual reality teaching system as claimed in claim 1,
wherein the teaching server includes a member module; and
wherein, when the teaching information device is connected to the teaching server, the member module is used to confirm whether the teaching information device is a registered member according to a member information of the database module, and to give the teaching information device an permission level.

7. The multi-person synchronous remote virtual reality teaching system as claimed in claim 6,
wherein the member module is used by the teaching information device to change the permission level of an authorized person.

8. The multi-person synchronous remote virtual reality teaching system as claimed in claim 1,
wherein the teaching module is used by the teaching information device to control a second display module of the learning information device to synchronize with a first display module of the teaching information device such that the learning information device is changed from a free exploration mode to a guidance mode.

9. The multi-person synchronous remote virtual reality teaching system as claimed in claim 1,
wherein the teaching module allows the teaching information device or the learning information device to ask one or more questions to each other according to the virtual reality teaching information during the course; and
wherein the teaching module synchronously stores these questions in the database module.

10. The multi-person synchronous remote virtual reality teaching system as claimed in claim 1,
wherein the teaching module allows the teaching information device to share a supplementary information to the learning information device during the virtual reality teaching course; and
wherein the teaching module synchronously stores the supplementary information in the database module.

11. The multi-person synchronous remote virtual reality teaching system as claimed in claim 1,
wherein the teaching module allows the learning information device to read the integrated information when the directivity of the learning information device is aligned with an information symbol in the virtual reality scene during the virtual reality teaching course.

12. The multi-person synchronous remote virtual reality teaching system as clammed in claim 1,
wherein the teaching server includes a monitoring module;
wherein the monitoring module is used by the teaching information device to monitor the downloading and integrating progress of the learning information device; and
wherein one or more pieces of progress information are presented through a first display module.

13. The multi-person synchronous remote virtual reality teaching system as claimed in claim 12,
wherein the monitoring module is used for the teaching information device to monitor the learning information device through a browsing sign in the virtual reality scene during the virtual reality teaching course.

14. The multi-person synchronous remote virtual reality teaching system as claimed in claim 1,
wherein, when the virtual reality classroom includes the plurality of virtual reality teaching courses, the second central processing module automatically downloads the virtual reality teaching information and the introduction information specified by the teaching information device; and
wherein the rest of the virtual reality teaching information and the introduction information are downloaded as a series of streaming media during the virtual reality teaching course.

15. A method for implementing a multi-person synchronous remote virtual reality teaching system, comprising:
creating a virtual reality teaching course by use of a teaching information device on a teaching server through a first network, converting the virtual reality teaching course into a link information, and sharing the link information to a learning information device through a second network;
downloading a virtual reality teaching information and an introduction information in the database module by use of the teaching information device after the virtual reality teaching course is created selectively or automatically if the module has been preset, executing an edge operation to integrate the virtual reality teaching information and the introduction information, and then storing the integrated information in the first storage module; and
downloading the integrated information from the teaching information device automatically by use of the learning information device and then storing the integrated information after the learning information device joins the virtual reality teaching course through the link information.

16. The method for implementing a multi-person synchronous remote virtual reality teaching system as claimed in claim 15, wherein, when the learning information device is in information connection with the teaching server through the first network, the learning information device automatically downloads the integrated information from the teaching server, executes an edge operation to integrate the virtual reality teaching information and the introduction information into the integrated information, and then stores the integrated information.

17. The method for implementing a multi-person synchronous remote virtual reality teaching system as claimed in claim 15, wherein a virtual reality classroom is created simultaneously when the virtual reality teaching course is created.

18. The method for implementing a multi-person synchronous remote virtual reality teaching system as claimed in claim 15, wherein a virtual reality classroom is created in advance before the virtual reality teaching course is created.

19. The method for implementing a multi-person synchronous remote virtual reality teaching system as claimed in claim 15, wherein a previous virtual reality classroom or a previous virtual reality teaching course is created according to a previous course record in the teaching server when the virtual reality course is created.

20. The method for implementing a multi-person synchronous remote virtual reality teaching system as claimed in claim 15, wherein
wherein the teaching information device sends a login information to the teaching server;
wherein the teaching server compares the login information with a member information; and
wherein, if both of the information are matched to each other, the teaching server determines that the teaching information device is a registered member, thereby assigning a first-level permission level to the teaching information device.

21. The method for implementing a multi-person synchronous remote virtual reality teaching system as claimed in claim 20, wherein, if the login information and the member information include an identification code, the permission level can only be specified as the first-level permission based on the identification code without determining whether the login information matches the member information

22. The method for implementing a multi-person synchronous remote virtual reality teaching system as claimed in claim 15, wherein the permission level of an authorized person is changeable according to a permission message sent by the teaching information device.

23. The method for implementing a multi-person synchronous remote virtual reality teaching system as claimed in claim 15, wherein the downloading and integrating progress of the learning information device is sent to the teaching information device in one batch or in batches for display.

24. The method for implementing a multi-person synchronous remote virtual reality teaching system as claimed in claim 15, wherein, according to a control signal sent by the teaching information device, the display of the learning information device is switched and controlled to synchronize with the display of the teaching information device, such that the learning information device enters a guidance mode from a free exploration mode.

25. The method for implementing a multi-person synchronous remote virtual reality teaching system as claimed in claim 15, wherein, according to a test information sent by the teaching information device, one or more questions are raised to the learning information device, and the test information is simultaneously stored in the teaching server.

26. The method for implementing a multi-person synchronous remote virtual reality teaching system as claimed in claim 15, wherein, according to a supplementary information sent by the teaching information device, additional learning information is sent to the learning information device, and the supplementary information is simultaneously stored in the teaching server.

27. The method for implementing a multi-person synchronous remote virtual reality teaching system as claimed in claim 15, wherein, according to a browsing location information transmitted by the learning information device, the learning status of the learning information device is notified to the teaching information device.

28. The method for implementing a multi-person synchronous remote virtual reality teaching system as claimed in claim 15, wherein, when the virtual reality classroom includes several virtual reality teaching courses, the second central processing module automatically downloads the virtual reality teaching information and the introduction information specified by the teaching information device while the rest of the virtual reality teaching information and the introduction information are downloaded in a stream of streaming media when the virtual reality teaching course is in progress.
